(19) United States
(12) Patent Application Publication
(10) Pub. No.: US 2022/0308712 A1
(43) Pub. Date: Sep. 29, 2022

(54) INTELLIGENT INTERACTIVE METHOD, DEVICE AND APPARATUS FOR TOUCH DISPLAY DEVICE AND STORAGE MEDIUM

(71) Applicant: BOE TECHNOLOGY GROUP CO., LTD., Beijing (CN)

(72) Inventor: Yangyang ZHANG, Beijing (CN)

(21) Appl. No.: 17/429,211

(22) PCT Filed: Oct. 29, 2020
(86) PCT No.: PCT/CN2020/124912

§ 371 Date: Aug. 6, 2021

(51) Int. Cl. G06F 3/0482; G06F 3/04883

(52) U.S. Cl. CPC G06F 3/0482; G06F 3/04883

(57) ABSTRACT

The present disclosure relates to the field of display technology, and specifically, to an intelligent interactive method, device and apparatus for a touch display device, and a non-volatile computer-readable storage medium. The method includes configuring, in response to a first operation of a user on the toolbar, first parameter information of a first function, and activating the first function based on the first parameter information; generating a first activating flag based on the first function and the first parameter information; and activating, in response to a triggering operation of the user on the first activating flag, the first function based on the first parameter information.

### CROSS-REFERENCE TO RELATED APPLICATION

The present application is a national phase application under 35 U.S.C. § 371 of International Application No. PCT/CN2020/124912 filed on Oct. 29, 2020, the entire contents of which are incorporated herein by reference.

### TECHNICAL FIELD

The present disclosure relates to the field of display technology and, in particular, to an intelligent interactive method, device and apparatus for a touch display device, and a non-volatile computer-readable storage medium.

### BACKGROUND

With the rapid development of display technology, the use of a touch display device with a large size in a conference, a classroom, and other settings has become more popular.

In the existing touch display product, when the display interface of the touch display device is large, there may be a problem that interaction between an application interface of the touch display device and a user is inconvenient.

### SUMMARY

A first aspect of the present disclosure provides an intelligent interactive method for a touch display device. The touch display device includes at least one application that can display a toolbar, and the intelligent interactive method includes:

configuring, in response to a first operation of a user on the toolbar, first parameter information of a first function, and activating the first function based on the first parameter information;

generating a first activating flag based on the first function and the first parameter information; and

activating, in response to a triggering operation of the user on the first activating flag, the first function based on the first parameter information.

In an exemplary embodiment of the present disclosure, the intelligent interactive method further includes:

configuring, in response to a second operation of the user on the toolbar, second parameter information of the first function, and activating the first function based on the second parameter information;

generating a second activating flag based on the first function and the second parameter information; and

activating, in response to a triggering operation of the user on the second activating flag, the first function based on the second parameter information,

the first parameter information is different from the second parameter information.

In an exemplary embodiment of the present disclosure, the intelligent interactive method further includes:

configuring, in response to a third operation of the user on the toolbar, third parameter information of a second function, and activating the second function based on the third parameter information;

generating a third activating flag based on the second function and the third parameter information; and

activating, in response to a triggering operation of the user on the third activating flag, the second function based on the third parameter information,

the second function is different from the first function.

In an exemplary embodiment of the present disclosure, the intelligent interactive method further includes:

adjusting, in response to a fourth operation of the user on the first activating flag, the first parameter information.

In an exemplary embodiment of the present disclosure, the adjusting, in response to the fourth operation of the user on the first activating flag, the first parameter information includes:

displaying, in response to the fourth operation of the user on the first activating flag, a parameter selection menu of the first activating flag; and

adjusting, in response to a fifth operation of the user on the parameter selection menu, the first parameter information.

In an exemplary embodiment of the present disclosure, the intelligent interactive method further includes:

differently displaying an activating flag corresponding to a currently activated function of the touch display device.

In an exemplary embodiment of the present disclosure, the intelligent interactive method further includes:

in response to the triggering operation of the user on the first activating flag, activating the first function with the first parameter information, and hiding the first activating flag.

In an exemplary embodiment of the present disclosure, the generating the first activating flag based on the first function and the first parameter information includes:

in response to a sixth operation of the user under the first function, processing a display frame of the touch display device and generating the first activating flag.

In an exemplary embodiment of the present disclosure, generating the first activating flag in response to the sixth operation of the user under the first function includes:

generating, in response to end of the sixth operation, the first activating flag in a predetermined area of an end position of the sixth operation.

In an exemplary embodiment of the present disclosure, the generating, in response to that the user stops the sixth operation, an activating flag of at least one function in the predetermined area of the end position of the sixth operation includes:

generating the activating flag of the at least one function at the end position of the sixth operation; or

generating and displaying the activating flag in a blank area having a predetermined distance from the end position of the sixth operation.

In an exemplary embodiment of the present disclosure, the first function includes a writing function, the sixth operation includes a writing operation, and the processing the display frame of the touch display device in response to the sixth operation of the user under the first function with the first parameter information includes:

in response to the writing operation of the user on the display frame of the touch display device, recognizing a writing track of the writing operation, and generating a pattern corresponding to the writing track based on the first parameter information.

In an exemplary embodiment of the present disclosure, when the sixth operation ends, the intelligent interactive method includes:

determining, in response to that the user activates another function, that the sixth operation ends; or

determining, in response to that the user does not perform the sixth operation within a predetermined time, that the sixth operation ends.

In an exemplary embodiment of the present disclosure, the intelligent interactive method further includes:

deleting, in response to a deletion operation of the user on the activating flag, the activating flag corresponding to the deletion operation.

In an exemplary embodiment of the present disclosure, the application includes a writing board, the first function includes a writing function, the first parameter information includes a writing color and a writing style of the writing function, and a width of a writing track of the writing function.

An aspect of the present disclosure provides an intelligent interactive device for a touch display device, includes:

a touch screen;

a processor, coupled to the touch screen; and

a memory, configured to store one or more programs that, when being executed by the one or more processors, cause the one or more processors to implement any one of the intelligent interactive methods described above.

An aspect of the present disclosure provides a non-volatile computer-readable storage medium having a computer program stored thereon, wherein when the program is executed by a processor, any one of the intelligent interactive methods described above is implemented.

It should be understood that the above general description and the following detailed description are only exemplary and explanatory, and cannot limit the present disclosure.

### BRIEF DESCRIPTION OF THE DRAWINGS

The drawings herein are incorporated into the specification and constitute a part of the specification, show embodiments that conform to the present disclosure, and together with the specification, serve to explain the principle of the present disclosure. Understandably, the drawings in the following description are only some embodiments of the present disclosure, and other drawings can be obtained by those skilled in the art from these drawings without creative work. In which:

FIG. 1 schematically shows a flow chart of an intelligent interactive method of a touch display device in an exemplary embodiment of the present disclosure;

FIG. 2 schematically shows a schematic diagram of displaying a toolbar in a touch display device in an exemplary embodiment of the present disclosure;

FIG. 3 schematically shows a schematic diagram of a first activating flag in an exemplary embodiment of the present disclosure;

FIG. 4 schematically shows a schematic diagram of differently displaying activating flags in an exemplary embodiment of the present disclosure;

FIG. 5 schematically shows a schematic diagram of simultaneously displaying activating flags with different functions in an exemplary embodiment of the present disclosure;

FIG. 6 schematically shows a schematic diagram of a parameter selection menu in an exemplary embodiment of the present disclosure;

FIG. 7 schematically shows a flowchart of switching parameters for the same function in an exemplary embodiment of the present disclosure;

FIG. 8 schematically shows a flowchart of switching between different functions in an exemplary embodiment of the present disclosure;

FIG. 9 schematically shows a schematic diagram of a structure of an intelligent interactive device of a touch display device in an exemplary embodiment of the present disclosure;

FIG. 10 schematically shows a structural diagram of a computer system suitable for implementing an intelligent interactive device of a touch display device in an exemplary embodiment of the present disclosure; and

FIG. 11 schematically shows a schematic diagram of a computer-readable storage medium according to some embodiments of the present disclosure.

### DETAILED DESCRIPTION

Example embodiments will now be described more fully with reference to the accompanying drawings. However, the example embodiments may be implemented in various forms, and should not be construed as being limited to examples set forth herein; on the contrary, these embodiments are provided so that the present disclosure will be more comprehensive and complete, and the concept of the example embodiments will be fully conveyed to those skilled in the art. The described features, structures, or characteristics may be combined in one or more embodiments in any suitable way.

In addition, the drawings are only schematic illustrations of the present disclosure, and are not necessarily drawn to scale. The same reference numerals in the figures denote the same or similar parts, and thus the repeated description thereof will be omitted. Some of the block diagrams shown in the drawings are functional entities and do not necessarily correspond to physically or logically independent entities. These functional entities may be implemented in the form of software, or implemented in one or more hardware modules or integrated circuits, or implemented in different networks and/or processor devices and/or microcontroller devices.

First, an exemplary embodiment provides an intelligent interactive method for a touch display device, and the touch display device includes at least one application that can display a toolbar. Referring to FIG. 1, the intelligent interactive method for the touch display device may include the following steps:

S110, configuring, in response to a first operation of a user on the toolbar, first parameter information of a first function, and activating the first function based on the first parameter information;

S120, generating a first activating flag based on the first function and the first parameter information; and

S130, activating, in response to a triggering operation of the user on the first activating flag, the first function based on the first parameter information.

In the intelligent interactive method for the touch display device provided in the exemplary embodiment, compared with the related art, after the user performs the first operation on the toolbar, the first parameter information of the first function is configured, and the first function is activated based on the first parameter information; the first activating flag is generated according to the first function and the first parameter information; and, in response to the triggering operation of the user on the first activating flag, the first function is activated based on the first parameter information.

When the user wants to activate the first function again, he/she may directly click the first activating flag without having to configure the required first parameter information again in the toolbar 211 in corner of a display area 210 of the touch display device 200, which facilitates the interaction between the user and the touch display device 200, and improves the user experience.

Hereinafter, each step of the intelligent interaction method for the touch display device in the exemplary embodiment will be described in more detail with reference to the accompanying drawings and embodiments.

In step S110, the first parameter information of the first function is configured in response to the first operation of the user on the toolbar, and the first function is activated based on the first parameter information.

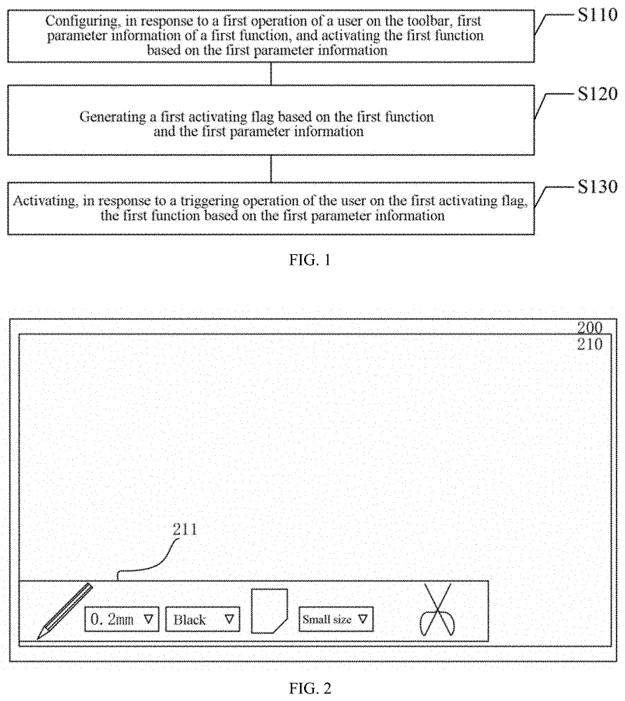

In an exemplary embodiment of the present disclosure, as shown in FIG. 2, at least one application of a touch display device 200 may display a toolbar 211. The toolbar 211 may be located at an edge of the touch display device 200. The toolbar 211 may be arranged at the upper edge, lower edge, and the like of a display area 210 of the touch display device 200, or may also be set according to user requirements, which is not specifically limited in the exemplary embodiment.

In the exemplary embodiment, the application described above may include a writing pad, a drawing pad, and the like, which is not specifically limited in the exemplary embodiment.

In the exemplary embodiment, a server of the touch display device 200 may configure the first parameter information of the first function in response to the first operation of the user on the toolbar 211, and activate the first function based on the first parameter information. The first function may include a writing function, an erasing function, a cropping function, and a graphic placement function, which is not specifically limited in the exemplary embodiment.

Specifically, the first operation described above may be that the user clicks on the toolbar multiple times to determine the first function and the parameter information of the first function respectively. The first operation may be that the user uses a finger to trigger a function in the toolbar 211, or activates the first function through a mouse, keyboard, gesture, and the like, and configures the first parameter information related to the first function. For example, when the user determines that a required function is the writing function, the user selects the writing function in the toolbar 211, and selects the parameter information corresponding to the writing function, for example, a weight, color, and line type (e.g., a writing style) of a writing track when writing. For example, the color of the writing track of the selected writing function is black, the weight is 0.2 mm and the like. The writing style may include for example a brush style, a pen style, a pencil style, and the like, which is not specifically limited in the exemplary embodiment.

In another exemplary embodiment of the present disclosure, the first function may be an erasing operation for erasing pattern displayed on the touch display device 200. At this time, the flag corresponding to the erasing function displayed on the toolbar 211 may be an eraser. A processor (e.g., a hardware processor) responds to that the user selects the erasing function in the toolbar 211 and sets the first parameter information of the erasing function. For example, the erasing is the size, shape, and erasing direction of the eraser, which is not specifically defined in the exemplary embodiment of the present disclosure.

In step S120, the first activating flag is generated according to the first function and the first parameter information.

In an exemplary embodiment of the present disclosure, referring to FIG. 2, after the first operation is received, the first activating flag 212 may be generated according to the above first function and the above first parameter information.

In the exemplary embodiment, the first activating flag may be directly generated after the user completes the first operation, or the first activating flag 212 may be generated in response to a sixth operation of the user under the first function. The first activating flag 212 may be generated when the sixth operation starts. The first activating flag 212 may be generated after the sixth operation ends.

In a case where the first activating flag is generated directly after the user completes the first operation and the above first activating flag 212 is generated when the sixth operation of the user starts, the position of the first activating flag 212 may be in a blank area of the display area of the touch display device.

A specific situation of generating the first activating flag after the sixth operation ends will be described in detail below.

In the exemplary embodiment, after the user selects the first function, the server may process a display frame of the touch display device 200 according to the first function in response to the sixth operation of the user under the first function.

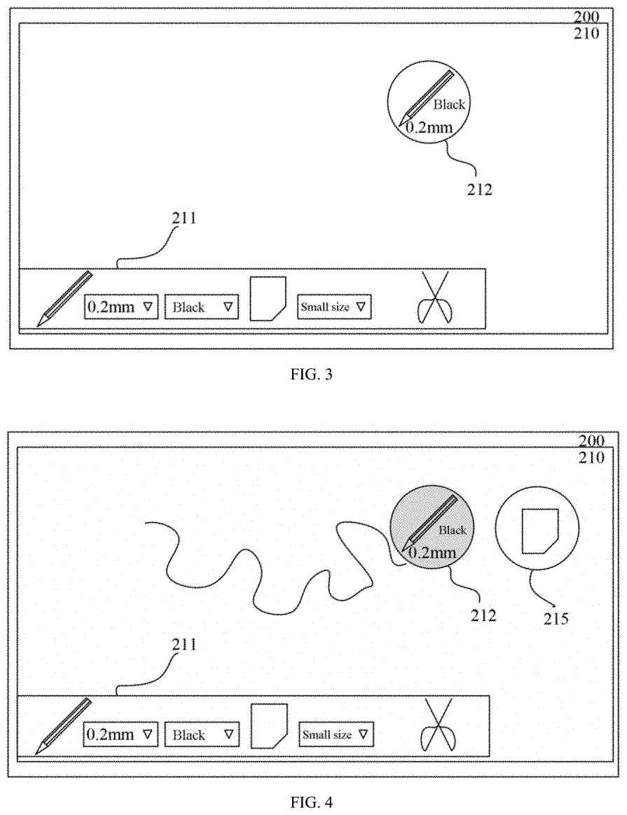

Specifically, as shown in FIG. 3, when the above first function is the writing function, the above sixth operation is the writing operation. The server may detect the track of the above writing operation, and according to the track and the parameter information of the first function, forms a pattern corresponding to the writing operation and displays the pattern on a display interface of the above touch display device 200.

In the exemplary embodiment, when the above first function is the erasing function, the above sixth operation is the erasing operation. At this time, the server may detect the track of the above erasing operation, and according to the parameter information of the above erasing function, i.e., unit erasing area and erasing angle of the erasing function, erase a pattern displayed on the touch display device 200. The unit erasing area refers to the area covered by the erasing function when the user moves one unit distance, and the unit distance may be 1 cm or 1 mm, which is not specifically limited in the exemplary embodiment.

Then, when the user stops the sixth operation, the first activating flag 212 is generated in a predetermined area of the end position of the sixth operation.

In an exemplary embodiment of the present disclosure, when the user stops the above sixth operation, the above first activating flag 212 is generated in the predetermined area of the end position of the sixth operation. Specifically, when the above sixth operation ends, the first activating flag is generated at the end position of the sixth operation, and the specific function and parameters of the first activating flag are determined by the above first operation.

In the exemplary embodiment, it may be determined that the above sixth operation ends when the user does not perform the above sixth operation within a predetermined time, and the predetermined time may be 1 second, 2 seconds, and so on, which may also be set according to user need, which is not specifically limited in the exemplary embodiment.

In another exemplary embodiment of the present disclosure, it may also be determined that the above sixth operation ends when the user activates other functions than the first function.

It should be noted that there are various methods to determine the end of the above sixth operation. The other method may be that for example the user stops the sixth operation through a gesture and the like. In the exemplary embodiment, the method of stopping the sixth operation is not specifically limited.

In the exemplary embodiment, as shown in FIG. 4, if a plurality of first activating flags 212 are displayed on the display interface of the touch display device, the electronic flag corresponding to the function currently used by the touch display device 200 is displayed differentially. For example, the activating flag 212 is darken, or a frame is added around the first activating flag 212, or a mark is added in the upper right corner of the flag corresponding to the current activated function, and the mark may be a check mark, a dot mark and the like, which is not specifically limited in the exemplary embodiment.

In the exemplary embodiment, when the above function is the writing function, the first activating flag 212 may be a pen symbol; when the above function is the erasing function, the above first activating flag 212 may be an eraser symbol; and when the above function is the cropping function, the above first activating flag 212 may be a scissors symbol. There may be various functions, that is, the first activating flag 212 may also include a plurality of types, and the specific type of the first activating flag 212 is not specifically limited in the exemplary embodiment of the present disclosure.

In the exemplary embodiment, the first activating flag 212 may include the parameter information corresponding to the function, that is, a pattern related to the parameter information is displayed on the first activating flag 212. For example, when the above function is the writing operation, a pen may be displayed on the first activating flag 212, and the writing color and weight of the pen is displayed additionally on the first activating flag 212. Specifically, a text may be used to display color on the first activating flag 212, for example, when the writing color of the writing function is red, the text “red” may be displayed in a corner of the first activating flag 212. Optionally, a pen tip of the pen displayed in the above first activating flag 212 may be provided with a desired color, for example, when the writing color of the writing function is black, the pen tip part of the pen pattern of the above first activating flag 212 is set to be black.

In the exemplary embodiment, the position where the above first activating flag 212 is generated may be at the end position of the above sixth operation, or may be in a blank area with a predetermined distance from the end position of the above sixth operation, and the predetermined distance may be 1 cm, 2 cm, and the like, which is not specifically limited in the exemplary embodiment. The blank area may be a position where the display area 210 of the touch display device 200 does not display a pattern, or may be an area where the user does not perform an operation, for example, an area where the user does not write.

In step S130, the first function is activated based on the first parameter information in response to the triggering operation of the user on the first activating flag.

In an exemplary embodiment of the present disclosure, the server may activate, in response to the triggering operation of the user on the above first activating flag 212, the above first function based on the above first parameter information. The triggering operation may be that the user clicks on the above first activating flag 212, or selects the first activating flag 212 through a gesture, or triggers the above first activating flag 212 through a keyboard or mouse. The specific manner of the triggering operation is not specifically limited in the exemplary embodiment.

In the example embodiment, the server may also adjust, in response to a fourth operation of the user on the first activating flag 212, the parameter information of the function corresponding to the first activating flag 212 corresponding to the fourth operation. Specifically, the above fourth operation may be that the user clicks twice the first activating flag 212, or the user expands the above first activating flag 212 through a gesture, for example, the user selects the above first activating flag 212 with the gesture and performs a sliding operation in any direction. Optionally, the user may use a mouse or keyboard to complete the above fourth operation.

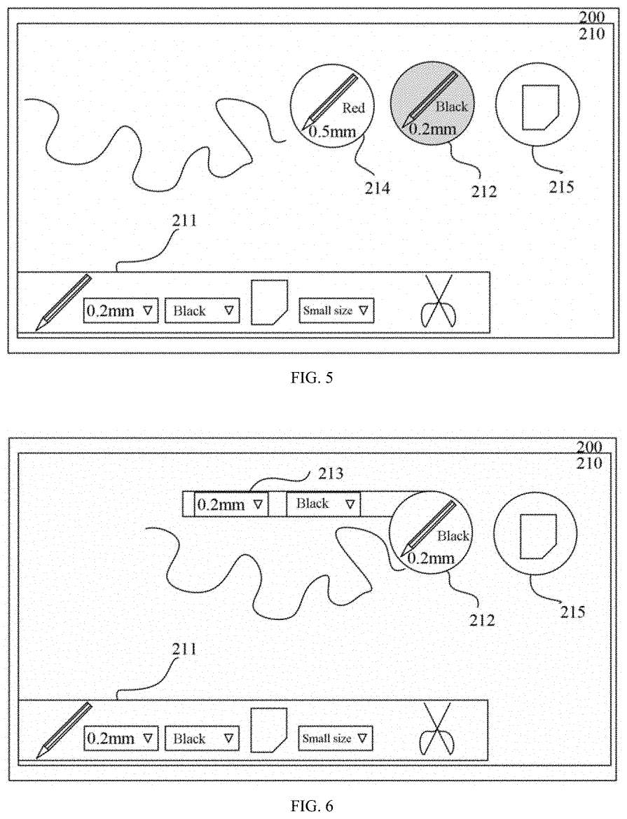

In the exemplary embodiment, as shown in FIG. 6, the above server receives the fourth operation of the user by generating a parameter selection menu 213 at a predetermined position of the activating flag 212 corresponding to the fourth operation, and the server adjusts the parameter information of the function corresponding to the activating flag 212 in response to the fourth operation of the user on the parameter selection menu 213. The fourth operation may be the selection operation of the user on the parameter information in the parameter selection menu 213, specifically, the fourth operation may be that the user clicks on the required parameter information of the parameter selection menu 213 through the touch panel. For example, when the function corresponding to the above first activating flag 212 is the writing function, the parameter selection menu 213 may display a plurality of writing colors of the writing function such as red, black, blue, purple and the like, and a plurality of weights of the writing lines such as 0.2 mm, 0.3 mm, 0.1 mm and the like. When the parameter information required by the user includes black and 0.2 mm, the user may respectively click the positions corresponding to “black” and “0.2 mm” in the parameter selection menu 213 to adjust the parameter information of the writing function.

In the exemplary embodiment, the intelligent interactive method for the touch display device 200 may further include activating, in response to the triggering operation of the user on the first activating flag 212, the above first activating flag based on the first parameter information, so that when the user needs to use the first function with the first parameter information again, she/he does not have to perform selection in the toolbar and configure parameter again, which increases interaction efficiency and enhances user experience.

In the exemplary embodiment, after the user triggers the above first activating flag 212, the first activating flag 212 is hidden, and after the user completes the interaction with the touch display device, the above first activating flag is displayed again. The user completing the interaction with the touch display device may be that the user does not operate the above touch display device within a predetermined time. The predetermined time may be 1 second, 2 seconds, and the like, or may be set according to user requirements, which is not specifically limited in the exemplary embodiment.

In the exemplary embodiment, when the user no longer needs the first activating flag in the display area, the above first activating flag 212 may be deleted in response to the deletion operation of the user on the above first activating flag, which may prevent the first activating flag 212 from occupying the above display area. The above deletion operation may be realized by a long pressing operation on the above first activating flag 212, may also be realized by mouse and keyboard, and may also be realized by other operations such as gesture commands, which is not specifically limited in the exemplary embodiment.

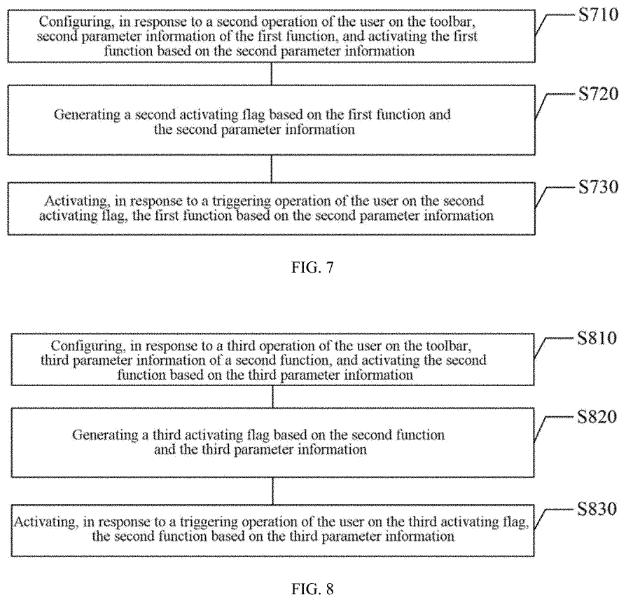

In an exemplary embodiment of the present disclosure, referring to FIG. 7, the intelligent interactive method for the touch display device 200 may further include steps S710 to S730, which specifically includes:

step S710, configuring, in response to a second operation of the user on the toolbar, second parameter information of the first function, and activating the first function based on the second parameter information;

step S720, generating a second activating flag based on the first function and the second parameter information; and

step S730, activating, in response to a triggering operation of the user on the second activating flag, the first function based on the second parameter information.

The above steps are described in detail below.

In step S710, the second parameter information of the first function is configured in response to the second operation of the user on the toolbar, and the first function is activated based on the second parameter information.

In the exemplary embodiment, the server of the touch display device 200 may configure the second parameter information of the first function in response to the first operation of the user on the toolbar 211, and activate the first function based on the second parameter information. The first function may include a writing function, erasing function, cropping function, and graphic placement function, which is not specifically limited in the exemplary embodiment.

Specifically, the first operation described above may be that the user clicks on the toolbar multiple times to determine the first function and the parameter information of the first function respectively. The first operation may be that the user uses a finger to trigger a function in the above toolbar 211, or activates the first function through a mouse, keyboard, gesture, and the like, and configures the second parameter information related to the first function. For example, when the user determines that a required function is the writing function, the user selects the writing function in the toolbar 211, and selects the parameter information corresponding to the writing function, for example, a weight, color, and line type of a writing track when writing. For example, the color of the writing track of the selected writing function is black, the weight is 0.2 mm and the like, which is not specifically limited in the exemplary embodiment.

In another exemplary embodiment of the present disclosure, the first function may be an erasing operation for erasing pattern displayed on the touch display device 200. At this time, the flag corresponding to the erasing function displayed on the toolbar 211 may be an eraser. A processor responds to that the user selects the erasing function in the toolbar 211 and sets the second parameter information of the erasing function. For example, the erasing is the size, shape, and erasing direction of the eraser, which is not specifically defined in the exemplary embodiment of the present disclosure.

In step S720, the second activating flag is generated based on the first function and the second parameter information.

In an exemplary embodiment of the present disclosure, as shown in FIG. 2, after the second operation is received, a second activating flag may be generated according to the above first function and the above second parameter information.

In the exemplary embodiment, the second activating flag may be directly generated after the user completes the second operation, or the activating flag may be generated in response to a sixth operation of the user under the first function. The second activating flag may be generated when the sixth operation of the user starts. The second activating flag may be generated after the sixth operation ends.

In a case where the second activating flag is generated directly after the user completes the second operation and the above second activating flag is generated when the sixth operation of the user starts, the position of the first activating may be in a blank area of the display area of the touch display device.

A specific situation of generating the second activating flag after the sixth operation ends will be described in detail below.

In the exemplary embodiment, after the user selects the first function, the server may process a display frame of the touch display device 200 according to the first function in response to the sixth operation of the user under the first function.

Specifically, as shown in FIG. 3, when the above first function is the writing function, the above sixth operation is the writing operation. The server may detect the track of the above writing operation, and according to the track and the parameter information of the first function, forms a pattern corresponding to the writing operation and displays the pattern on a display interface of the above touch display device 200.

In the exemplary embodiment, when the above first function is the erasing function, the above sixth operation is the erasing operation. At this time, the server may detect the track of the above erasing operation, and according to the parameter information of the above erasing function, i.e., unit erasing area and erasing angle of the erasing function, erase a pattern displayed on the touch display device 200. The unit erasing area refers to the area covered by the erasing function when the user moves one unit distance, and the unit distance may be 1 cm or 1 mm, which is not specifically limited in the exemplary embodiment.

Then, when the user stops the sixth operation, the second activating flag 214 is generated in a predetermined area of the end position of the sixth operation.

In an exemplary embodiment of the present disclosure, when the user stops the above sixth operation, the above second activating flag 214 is generated in the predetermined area of the end position of the sixth operation. Specifically, when the above sixth operation ends, the second activating flag is generated at the end position of the sixth operation, and the specific function and parameters of the second activating flag are determined by the above second operation.

In the exemplary embodiment, it may be determined that the above sixth operation ends when the user does not perform the above sixth operation within a predetermined time, and the predetermined time may be 1 second, 2 seconds, and so on, which may also be set according to user need, which is not specifically limited in the exemplary embodiment.

In another exemplary embodiment of the present disclosure, it may also be determined that the above sixth operation ends when the user activates other functions than the first function.

It should be noted that there are various methods to determine the end of the above sixth operation. The other method may be that for example the user stops the sixth operation through a gesture and the like. In the exemplary embodiment, the method of stopping the sixth operation is not specifically limited.

In the exemplary embodiment, as shown in FIG. 4, if a plurality of second activating flags 214 are displayed on the display interface of the touch display device, the electronic flag corresponding to the function currently used by the touch display device 200 is displayed differentially. For example, the activating flag 212 is darken, or a frame is added around the second activating flag 214, or a mark is added in the upper right corner of the flag corresponding to the current activated function, and the mark may be a check mark, a dot mark and the like, which is not specifically limited in the exemplary embodiment.

In the exemplary embodiment, when the above function is the writing function, the second activating flag 214 may be a pen symbol; when the above function is the erasing function, the above second activating flag 214 may be an eraser symbol; and when the above function is the cropping function, the above second activating flag 214 may be a scissors symbol. There may be various functions, that is, the above second activating flag 214 may also include a plurality of types, and the specific type of the second activating flag 214 is not specifically limited in the exemplary embodiment of the present disclosure.

In the exemplary embodiment, the second activating flag 214 may include the parameter information corresponding to the function, that is, a pattern related to the parameter information is displayed on the second activating flag 214. For example, when the above function is the writing operation, a pen may be displayed on the second activating flag 214, and the writing color and weight of the pen is displayed additionally on the second activating flag 214. Specifically, a text may be used to display color on the second activating flag 214, for example, when the writing color of the writing function is red, the text “red” may be displayed in a corner of the second activating flag 214. Optionally, a pen tip of the pen displayed in the above second activating flag 214 may be provided with a desired color, for example, when the writing color of the writing function is black, the pen tip part of the pen pattern of the above second activating flag 214 is set to be black.

In the exemplary embodiment, the position where the above second activating flag 214 is generated may be at the end position of the above sixth operation, or may be in a blank area with a predetermined distance from the end position of the above sixth operation, and the predetermined distance may be 1 cm, 2 cm, and the like, which is not specifically limited in the exemplary embodiment. The blank area may be a position where the display area 210 of the touch display device 200 does not display a pattern, or may be an area where the user does not perform an operation, for example, an area where the user does not write.

In the exemplary embodiment, as shown in FIG. 5, two activating flags of the first function may be displayed in the display area of the touch display device, which respectively are a first activating flag and a second activating flag. The first parameter information of the first activating flag is different from the second parameter information of the second activating flag. For example, the first parameter information is black, and 0.2 mm; and the second parameter information is red, and 0.5 mm.

In the exemplary embodiment, the activating flag corresponding to the currently activated function may be displayed differentially. It may also be that only the activating flag corresponding to the function that is not activated is displayed on the display interface. For example, if the function corresponding to the first activating flag is currently activated, the first activating flag is displayed differentially. The specific content for differential displaying has been described above in detail, which will not be repeated herein.

In an exemplary embodiment of the present disclosure, if the function corresponding to the first activating flag is currently activated, only the second activating flag 214 may be displayed at this time, and the first activating flag 212 may not be displayed.

In step S730, the first function is activated based on the second parameter information in response to the triggering operation of the user on the second activating flag.

In an exemplary embodiment of the present disclosure, the server may activate, in response to the triggering operation of the user on the above second activating flag 214, the above first function based on the above second parameter information. The triggering operation may be that the user clicks on the above second activating flag 214, or selects the second activating flag 214 through a gesture, or triggers the above second activating flag 214 through a keyboard or mouse. The specific manner of the triggering operation is not specifically limited in the exemplary embodiment.

In the exemplary embodiment, the server may also adjust, in response to a fourth operation of the user on the second activating flag 214, the parameter information of the function corresponding to the second activating flag 214 corresponding to the fourth operation. Specifically, the above fourth operation may be that the user clicks twice the second activating flag 214, or the user expands the above second activating flag 214 through a gesture, for example, the user selects the above second activating flag 214 with the gesture and performs a sliding operation in any direction. Optionally, the user may use a mouse or keyboard to complete the above fourth operation.

In the exemplary embodiment, as shown in FIG. 6, the above server receives the fourth operation of the user by generating a parameter selection menu 213 at a predetermined position of the activating flag 212 corresponding to the fourth operation, and the server adjusts the parameter information of the function corresponding to the activating flag 212 in response to the fourth operation of the user on the parameter selection menu 213. The fourth operation may be the selection operation of the user on the parameter information in the parameter selection menu 213, specifically, the fourth operation may be that the user clicks on the required parameter information of the parameter selection menu 213 through the touch panel. For example, when the function corresponding to the above second activating flag 214 is the writing function, the parameter selection menu 213 may display a plurality of writing colors of the writing function such as red, black, blue, purple and the like, and a plurality of weights of the writing lines such as 0.2 mm, 0.3 mm, 0.1 mm and the like. When the parameter information required by the user includes black and 0.2 mm, the user may respectively click the positions corresponding to “black” and “0.2 mm” in the parameter selection menu 213 to adjust the parameter information of the writing function.

In the exemplary embodiment, the intelligent interactive method for the touch display device 200 may further include activating, in response to the triggering operation of the user on the second activating flag 214, the above first activating flag based on the second parameter information, so that when the user needs to use the first function with the second parameter information again, she/he does not have to perform selection in the toolbar and configure parameter again, which increases interaction efficiency and enhances user experience.

In the exemplary embodiment, after the user triggers the above second activating flag 214, the second activating flag 214 is hidden, and after the user completes the interaction with the touch display device, the above second activating flag 214 is displayed again. The user completing the interaction with the touch display device may be that the user does not operate the above touch display device within a predetermined time. The predetermined time may be 1 second, 2 seconds, and the like, or may be set according to user requirements, which is not specifically limited in the exemplary embodiment.

In the exemplary embodiment, when the user no longer needs the second activating flag in the display area, the above second activating flag 214 may be deleted in response to the deletion operation of the user on the above second activating flag, which may prevent the first activating flag 214 from occupying the above display area. The above deletion operation may be realized by a long pressing operation on the above second activating flag 214, may also be realized by mouse and keyboard, and may also be realized by other operations such as gesture commands, which is not specifically limited in the exemplary embodiment.

In an exemplary embodiment of the present disclosure, referring to FIG. 8, the intelligent interactive method for the touch display device 200 may further include steps S810 to S830, which specifically includes:

step S810, configuring, in response to a third operation of the user on the toolbar, third parameter information of a second function, and activating the second function based on the third parameter information;

step S820, generating a third activating flag based on the second function and the third parameter information; and

step S830, activating, in response to a triggering operation of the user on the third activating flag, the second function based on the third parameter information.

The above steps are described in detail below.

In step S810, the third parameter information of the second function is configured in response to the second operation of the user on the toolbar, and the second function is activated based on the third parameter information.

In the exemplary embodiment, the server of the touch display device 200 may configure the third parameter information of the second function in response to the first operation of the user on the toolbar 211, and activate the second function based on the third parameter information. The second function is different from the second function. That is, when the above first function is the writing function, the second function may be the erasing function, cropping function which is different from the first function, which is not specifically limited in the exemplary embodiment.

Specifically, the first operation described above may be that the user clicks on the toolbar multiple times to determine the second function and the parameter information of the second function respectively. The first operation may be that the user uses a finger to trigger a function in the above toolbar 211, or activates the second function through a mouse, keyboard, gesture, and the like, and configures the third parameter information related to the second function.

In another exemplary embodiment of the present disclosure, the second function may be an erasing operation for erasing pattern displayed on the touch display device 200. At this time, the flag corresponding to the erasing function displayed on the toolbar 211 may be an eraser. A processor responds to that the user selects the erasing function in the toolbar 211 and sets the third parameter information of the erasing function. For example, the erasing is the size, shape, and erasing direction of the eraser, which is not specifically limited in the exemplary embodiment of the present disclosure.

In step S820, the second activating flag is generated based on the second function and the third parameter information.

In an exemplary embodiment of the present disclosure, as shown in FIG. 2, after the second operation is received, the second activating flag may be generated according to the above second function and the above third parameter information.

In the exemplary embodiment, the second activating flag may be directly generated after the user completes the second operation, or the activating flag may be generated in response to a sixth operation of the user under the second function. The second activating flag may be generated when the sixth operation of the user starts. The second activating flag may be generated after the sixth operation ends.

In a case where the second activating flag is generated directly after the user completes the second operation and the above second activating flag is generated when the sixth operation of the user starts, the position of the first activating may be in a blank area of the display area of the touch display device.

A specific situation of generating the second activating flag after the sixth operation ends will be described in detail below.

In the exemplary embodiment, after the user selects the second function, the server may process a display frame of the touch display device 200 according to the second function in response to the sixth operation of the user under the second function.

Specifically, when the above second function is the erasing function, the above sixth operation is the erasing operation. The server may detect the track of the above erasing operation, and according to the track and the third parameter information of the second function, delete a pattern corresponding to the erasing operation on the display interface of the above touch display device 200.

Specifically, when the above second function is the erasing function, the above sixth operation is the erasing operation. At this time, the server may detect the track of the above erasing operation, and according to the parameter information of the above erasing function, i.e., unit erasing area and erasing angle of the erasing function, erase a pattern displayed on the touch display device 200. The unit erasing area refers to the area covered by the erasing function when the user moves one unit distance, and the unit distance may be 1 cm or 1 mm, which is not specifically limited in the exemplary embodiment.

Then, when the user stops the sixth operation, the third activating flag 215 is generated in a predetermined area of the end position of the sixth operation.

In an exemplary embodiment of the present disclosure, when the user stops the above sixth operation, the above third activating flag 215 is generated in the predetermined area of the end position of the sixth operation. Specifically, when the above sixth operation ends, the second activating flag is generated at the end position of the sixth operation, and the specific function and parameters of the second activating flag are determined by the above second operation.

In the exemplary embodiment, it may be determined that the above sixth operation ends when the user does not perform the above sixth operation within a predetermined time, and the predetermined time may be 1 second, 2 seconds, and so on, which may also be set according to user need, which is not specifically limited in the exemplary embodiment.

In another exemplary embodiment of the present disclosure, it may also be determined that the above sixth operation ends when the user starts other functions than the first function.

It should be noted that there are various methods to determine the end of the above sixth operation. The other method may be that for example the user stops the sixth operation through a gesture and the like. In the exemplary embodiment, the method of stopping the sixth operation is not specifically limited.

In the exemplary embodiment, as shown in FIG. 4, if a plurality of third activating flags 215 are displayed on the display interface of the touch display device, the electronic flag corresponding to the function currently used by the touch display device 200 is displayed differentially. For example, the activating flag 212 is darken, or a frame is added around the third activating flag 215, or a mark is added in the upper right corner of the flag corresponding to the currently activated function, and the mark may be a check mark, a dot mark and the like, which is not specifically limited in the exemplary embodiment.

In the exemplary embodiment, when the above function is the writing function, the third activating flag 215 may be a pen symbol; when the above function is the erasing function, the above third activating flag 215 may be an eraser symbol; and when the above function is the cropping function, the above third activating flag 215 may be a scissors symbol. There may be various functions, that is, the above third activating flag 215 may also include a plurality of types, and the specific type of the third activating flag 215 is not specifically limited in the exemplary embodiment of the present disclosure.

In the exemplary embodiment, the third activating flag 215 may include the parameter information corresponding to the function, that is, a pattern related to the parameter information is displayed on the third activating flag 215, which may refer to the above description of the first activating flag 214 and the second activating flag 214 for details.

In the exemplary embodiment, the position where the above third activating flag 215 is generated may be at the end position of the above sixth operation, or may be in a blank area with a predetermined distance from the end position of the above sixth operation, and the predetermined distance may be 1 cm, 2 cm, and the like, which is not specifically limited in the exemplary embodiment. The blank area may be a position where the display area 210 of the touch display device 200 does not display a pattern, or may be an area where the user does not perform an operation, for example, an area where the user does not write.

In the exemplary embodiment, as shown in FIG. 5, two activating flags of the first function may be displayed in the display area of the touch display device, which respectively are the first activating flag 212 and the second activating flag 214, and one third activating flag 215 of the second function may be further included. The first parameter information of the first activating flag is different from the second parameter information of the second activating flag. For example, the first parameter information is black, and 0.2 mm; the second parameter information is red, and 0.5 mm; and the third activating flag 215 may be an activating flag of the erasing function with small size.

In the exemplary embodiment, the activating flag corresponding to the currently activated function may be displayed differentially. It may also be that only the activating flag corresponding to the function that is not activated is displayed on the display interface. For example, if the function corresponding to the first activating flag 212 is currently activated, the first activating flag is displayed differentially. The specific content for differential displaying has been described above in detail, which will not be repeated herein.

In an exemplary embodiment of the present disclosure, if the function corresponding to the first activating flag is currently activated, only the second activating flag 214 and the third activating flag 215 may be displayed at this time, and the first activating flag 212 may not be displayed.

In step S830, the second function is activated based on the third parameter information in response to the triggering operation of the user on the second activating flag.

In an exemplary embodiment of the present disclosure, the server may activate, in response to the triggering operation of the user on the above third activating flag 215, the above second function based on the above third parameter information. The triggering operation may be that the user clicks on the above third activating flag 215, or selects the third activating flag 215 through a gesture, or triggers the above third activating flag 215 through a keyboard or mouse. The specific manner of the triggering operation is not specifically limited in the exemplary embodiment.

In the exemplary embodiment, the server may also adjust, in response to a fourth operation of the user on the third activating flag 215, the parameter information of the function corresponding to the third activating flag 215 corresponding to the fourth operation. Specifically, the above fourth operation may be that the user clicks twice the third activating flag 215, or the user expands the above third activating flag 215 through a gesture, for example, the user selects the above third activating flag 215 with the gesture and performs a sliding operation in any direction. Optionally, the user may use a mouse or keyboard to complete the above fourth operation.

In the exemplary embodiment, as shown in FIG. 6, the above server receives the fourth operation of the user by generating a parameter selection menu 213 at a predetermined position of the activating flag 212 corresponding to the fourth operation, and the server adjusts the parameter information of the function corresponding to the activating flag 212 in response to the fourth operation of the user on the parameter selection menu 213. The fourth operation may be the selection operation of the user on the parameter information in the parameter selection menu 213, specifically, the fourth operation may be that the user clicks on the required parameter information of the parameter selection menu 213 through the touch panel. For example, when the function corresponding to the above third activating flag 215 is the writing function, the parameter selection menu 213 may display a plurality of writing colors of the writing function such as red, black, blue, purple and the like, and a plurality of weights of the writing lines such as 0.2 mm, 0.3 mm, 0.1 mm and the like. When the parameter information required by the user includes black and 0.2 mm, the user may respectively click the positions corresponding to “black” and “0.2 mm” in the parameter selection menu 213 to adjust the parameter information of the writing function.

In the exemplary embodiment, the intelligent interactive method for the touch display device 200 may further include activating, in response to the triggering operation of the user on the third activating flag 215, the above first activating flag based on the third parameter information, so that when the user needs to use the second function with the third parameter information again, she/he does not have to perform selection in the toolbar and configure parameter again, which increases interaction efficiency and enhances user experience.

In the exemplary embodiment, after the user triggers the above third activating flag 215, the third activating flag 215 is hidden, and after the user completes the interaction with the touch display device, the above third activating flag 215 is displayed again. The user completing the interaction with the touch display device may be that the user does not operate the above touch display device within a predetermined time. The predetermined time may be 1 second, 2 seconds, and the like, or may be set according to user requirements, which is not specifically limited in the exemplary embodiment.

In the exemplary embodiment, when the user no longer needs the third activating flag in the display area, the above third activating flag 215 may be deleted in response to the deletion operation of the user on the above third activating flag, which may prevent the third activating flag 215 from occupying the above display area. The above deletion operation may be realized by a long pressing operation on the above third activating flag 215, may also be realized by mouse and keyboard, and may also be realized by other operations such as gesture commands, which is not specifically limited in the exemplary embodiment.

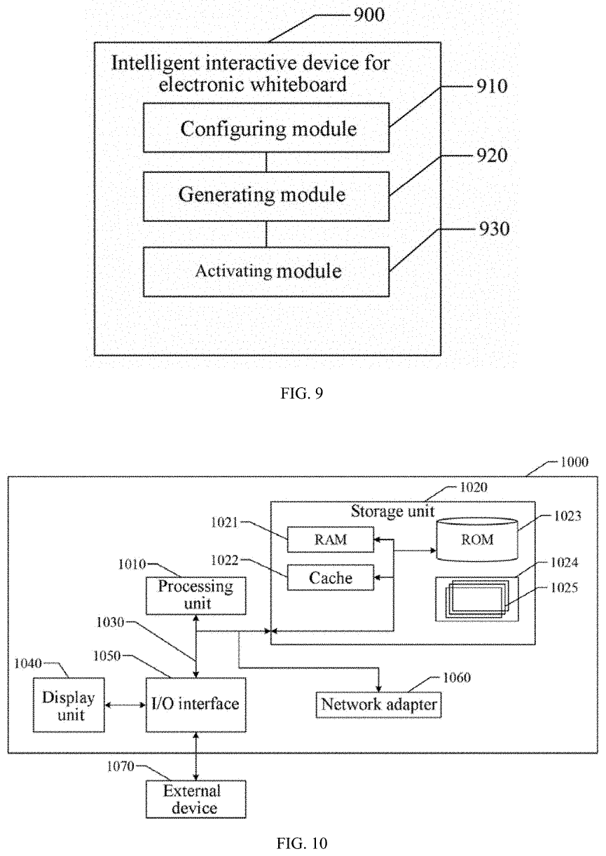

The following describes a device embodiment of the present disclosure, which may be used to implement the intelligent interactive method for the touch display device described above in the present disclosure. In addition, an exemplary embodiment of the present disclosure further provides an intelligent interactive device for a touch display device. Referring to FIG. 9, the intelligent interactive device 900 for the touch display device includes: a configuring module 910, a generating module 920, and an activating module 930.

The configuring module 910 may be configured to configure, in response to a first operation of a user on the toolbar, first parameter information of a first function, and activate the first function based on the first parameter information. The generating module 920 may be configured to generate a first activating flag based on the first function and the first parameter information. The activating module 930 may be configured to activate, in response to a triggering operation of the user on the first activating flag, the first function based on the first parameter information.

Since respective functional modules of the intelligent interactive device for the touch display device in the exemplary embodiment of the present disclosure correspond to the steps of the above intelligent interactive method for the touch display device in the exemplary embodiment, details that are not disclosed in the device embodiment of the present disclosure may refer to the embodiment of the intelligent interactive method for the touch display device in the present disclosure.

It should be noted that although several modules or units of the device for action execution are mentioned in the above detailed description, such division is not compulsory. In fact, according to an embodiment of the present disclosure, the features, and functions of two or more modules or units described above may be embodied in one module or unit. Conversely, the feature and function of one module or unit described above may be further divided to be embodied by a plurality of modules or units.

In addition, an exemplary embodiment of the present disclosure also provides an intelligent interactive device for a touch display device.

Those skilled in the art may understand that various aspects of the present disclosure may be implemented as a system, a method, or a program product. Therefore, various aspects of the present disclosure may be specifically implemented in the following forms, namely: a complete hardware embodiment, a complete software embodiment (including firmware, microcode, and the like), or a combination embodiment of hardware and software, which may be collectively referred herein as “circuit”, “module” or “system”.

An intelligent interactive device 1000 for a touch display device according to such embodiment of the present disclosure will be described below with reference to FIG. 10. The intelligent interactive device 1000 for the touch display device shown in FIG. 10 is only an example, and should not bring any limitation to the function and use scope of the embodiments of the present disclosure.

As shown in FIG. 10, the intelligent interactive device 1000 for the touch display device is represented in the form of a general-purpose computing device. The intelligent interactive device 1000 for the touch display device may include, but is not limited to: the above at least one processing unit 1010, the above at least one storage unit 1020, a bus 1030 connecting different system components (including the storage unit 1020 and the processing unit 1010), and a display unit 1040.

The storage unit stores program code, and the program code may be executed by the processing unit 1010, so that the processing unit 1010 executes the steps in the various exemplary embodiments the present disclosure described in the “exemplary method” section of this specification. For example, the processing unit 1010 may perform the following steps as shown in FIG. 1: S110, configuring, in response to a first operation of a user on the toolbar, first parameter information of a first function, and activating the first function based on the first parameter information; S120, generating a first activating flag based on the first function and the first parameter information; and S130, activating, in response to a triggering operation of the user on the first activating flag, the first function based on the first parameter information.

For another example, the electronic device may implement the steps shown in FIG. 1, FIG. 7, and FIG. 8.

The storage unit 1020 may include a readable medium in the form of a volatile storage unit, such as a random access storage unit (RAM) 1021 and/or a cache storage unit 1022, and may further include a read-only storage unit (ROM) 1023.

The storage unit 1020 may also include a program/utility tool 1024 having a set (at least one) of program module 1025. Such program module 1025 includes but is not limited to: an operating system, one or more application programs, other program modules, and program data. Each and some combination of these examples may include the implementation of a network environment.

The bus 1030 may be one or more of several types of bus structures, including a storage unit bus or a storage unit controller, a peripheral bus, a graphics acceleration port, a processing unit, or a local area using any bus structure of multiple bus structures.

The intelligent interactive device 1000 for the touch display device may also communicate with one or more external devices 1070 (such as keyboards, pointing devices, Bluetooth devices, and the like), and may further communicate with one or more devices that enable users to interact with intelligent interactive device 1000 for the touch display device, and/or communicate with any device (such as a router, a modem, and the like) that enables the intelligent interactive device 1000 for the touch display device to communicate with one or more other computing devices. The communication may be performed through an input/output (I/O) interface 1050. In addition, the intelligent interactive device 1000 for the touch display device may also communicate with one or more networks (for example, a local area network (LAN), a wide area network (WAN), and/or a public network, such as the Internet) through a network adapter 1060. As shown in the figure, the network adapter 1060 communicates with other modules of the intelligent interactive device 1000 for the touch display device through the bus 1030. It should be understood that although not shown in the figure, other hardware and/or software modules may be used in conjunction with the intelligent interactive device 1000 for the touch display device, including but not limited to: microcode, device driver, redundant processing unit, external disk drive array, RAID system, tape driver, and data backup storage system.

Through the description of the above embodiments, those skilled in the art may easily understand that the exemplary embodiments described here may be implemented by software, or may be implemented by combining software with necessary hardware. Therefore, the technical solution according to the embodiment of the present disclosure may be embodied in the form of a software product, and the software product may be stored in a non-volatile storage medium (which may be a CD-ROM, U disk, mobile hard disk, and the like) or on the network, including several instructions to make a computing device (which may be a personal computer, a server, a terminal device, a network device, or the like) execute the method according to the embodiments of the present disclosure.

An exemplary embodiment of the present disclosure further provides a computer-readable storage medium on which is stored a program product capable of implementing the above-mentioned method in the specification. In some possible embodiments, various aspects of the present disclosure may also be implemented in the form of a program product, which includes program code. When the program product runs on a terminal device, the program code is used to enable the terminal device to execute the steps in the various exemplary embodiments of the present disclosure described in the “exemplary method” section of this specification.

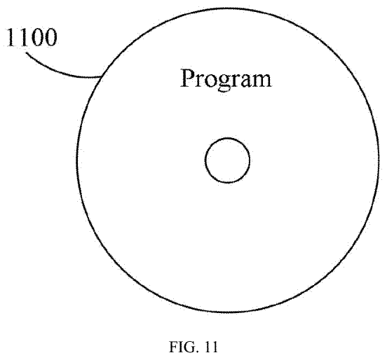

FIG. 11 describes a program product 1100 for implementing the above method according to an embodiment of the present disclosure. The program product 1100 may adopt a portable compact disk read-only memory (CD-ROM) and include program code, and may run on a terminal device such as a personal computer. However, the program product of the present disclosure is not limited thereto. In the present disclosure, the readable storage medium may be any tangible medium that contains or stores a program, and the program may be used by or in combination with an instruction execution system, device, or element.

The program product may use any combination of one or more readable media. The readable medium may be a readable signal medium or a readable storage medium. The readable storage medium may be, for example, but not limited to, an electrical, magnetic, optical, electromagnetic, infrared, or semiconductor system, device, or element, or a combination thereof. More specific examples (non-exhaustive list) of readable storage media include: electrical connection with one or more wires, portable disk, hard disk, random access memory (RAM), read-only memory (ROM), erasable programmable read only memory (EPROM or flash memory), optical fiber, portable compact disk read only memory (CD-ROM), optical storage device, magnetic storage device, or any suitable combination thereof.

The computer-readable signal medium may include a data signal propagated in baseband or as a part of a carrier wave, in which a readable program code is carried. This propagated data signal may take many forms, including but not limited to electromagnetic signal, optical signal, or any suitable combination thereof. The readable signal medium may also be any readable medium other than a readable storage medium, and the readable medium may send, propagate, or transmit a program for use by or in combination with the instruction execution system, device, or element.

The program code contained on the readable medium may be transmitted by any suitable medium, including but not limited to wireless, wired, optical cable, RF, or any suitable combination thereof.

The program code used to perform the operations of the present disclosure may be written in any combination of one or more programming languages. The programming languages include object-oriented programming languages such as Java, C++, and the like as well as conventional programming language such as “C” language or similar programming language. The program code may be executed entirely on a user computing device, executed partly on the user device, executed as an independent software package, executed partly on the user computing device and partly on a remote computing device, or executed entirely on the remote computing device or a server. In case of the remote computing device, the remote computing device may be connected to a user computing device through any kind of network, including a local area network (LAN) or a wide area network (WAN), or may be connected to an external computing device (for example, via the Internet using Internet service providers).

In addition, the above drawings are merely schematic illustrations of the processes included in the method according to the exemplary embodiments of the present disclosure, and are not intended for limitation. It may be understood that the processes shown in the above drawings does not indicate or limit the time sequence of these processes. In addition, it may be further understood that these processes may be executed synchronously or asynchronously in a plurality of modules, for example.

Those skilled in the art will easily conceive of other embodiments of the present disclosure after considering the specification and practicing the invention disclosed herein. The present disclosure is intended to cover any variations, uses, or adaptive changes of the present disclosure. These variations, uses, or adaptive changes follow the general principles of the present disclosure and include the common knowledge or conventional technical means in the technical field that are not disclosed in the present disclosure. The description and the embodiments are only regarded as exemplary, and the true scope and spirit of the present disclosure are pointed out by the claims.

It should be understood that the present disclosure is not limited to the precise structure that has been described above and shown in the drawings, and various modifications and changes may be made without departing from the scope thereof. The scope of the present disclosure is limited only by the appended claims.

1. An intelligent interactive method for a touch display device, comprising:
providing the touch display device, wherein the touch display device comprises at least one application that can display a toolbar;
configuring, in response to a first operation of a user on the toolbar, first parameter information of a first function, and activating the first function based on the first parameter information;
generating a first activating flag based on the first function and the first parameter information; and
activating, in response to a triggering operation of the user on the first activating flag, the first function based on the first parameter information.

2. The intelligent interactive method according to claim 1, further comprising:
configuring, in response to a second operation of the user on the toolbar, second parameter information of the first function, and activating the first function based on the second parameter information;
generating a second activating flag based on the first function and the second parameter information; and
activating, in response to a triggering operation of the user on the second activating flag, the first function based on the second parameter information, wherein the first parameter information is different from the second parameter information.

3. The intelligent interactive method according to claim 1, further comprising:
configuring, in response to a third operation of the user on the toolbar, third parameter information of a second function, and activating the second function based on the third parameter information;
generating a third activating flag based on the second function and the third parameter information; and
activating, in response to a triggering operation of the user on the third activating flag, the second function based on the third parameter information, wherein the second function is different from the first function.

4. The intelligent interactive method according to claim 1, further comprising adjusting, in response to a fourth operation of the user on the first activating flag, the first parameter information.

5. The intelligent interactive method according to claim 4, wherein adjusting, in response to the fourth operation of the user on the first activating flag, the first parameter information further comprises:
displaying, in response to the fourth operation of the user on the first activating flag, a parameter selection menu of the first activating flag; and
adjusting, in response to a fifth operation of the user on the parameter selection menu, the first parameter information.

6. The intelligent interactive method according to claim 1, further comprising differentially displaying an activating flag corresponding to a currently activated function of the touch display device.

7. The intelligent interactive method according to claim 1, further comprising, in response to the triggering operation of the user on the first activating flag, activating the first function with the first parameter information and hiding the first activating flag.

8. The intelligent interactive method according to claim 1, wherein generating the first activating flag based on the first function and the first parameter information further comprises:
in response to a sixth operation of the user under the first function, processing a display frame of the touch display device and generating the first activating flag.

9. The intelligent interactive method according to claim 8, wherein generating the first activating flag in response to the sixth operation of the user under the first function further comprises:
generating, in response to end of the sixth operation, the first activating flag in an area having a predetermined distance from end position of the sixth operation.

10. The intelligent interactive method according to claim 9, wherein generating, in response to the end of the sixth operation, the first activating flag in the area having the predetermined distance from the end position of the sixth operation further comprises:
generating and displaying the activating flag in a blank area having the predetermined distance from the end position of the sixth operation.

11. The intelligent interactive method according to claim 8, wherein:
the first function comprises a writing function, the sixth operation comprises a writing operation, and the processing the display frame of the touch display device in response to the sixth operation of the user under the first function further comprises:
in response to the writing operation of the user on the display frame of the touch display device, recognizing a writing track of the writing operation, and generating a pattern corresponding to the writing track based on the first parameter information.

12. The intelligent interactive method according to claim 8, wherein when the sixth operation ends, the intelligent interactive method comprises:
determining, in response to that the user activates another function, that the sixth operation ends; or
determining, in response to that the user does not perform the sixth operation within a predetermined time, that the sixth operation ends.

13. The intelligent interactive method according to claim 1, further comprising deleting, in response to a deletion operation of the user on the activating flag, the activating flag corresponding to the deletion operation.

14. The intelligent interactive method according to claim 1, wherein the application comprises a writing board, the first function comprises a writing function, the first parameter information comprises a writing color and a writing style of the writing function, and a width of a writing track of the writing function.

15. An intelligent interactive device for a touch display device, comprising:
a touch screen and at least one hardware processor, the at least one hardware processor being in data communication with the touch screen; and
memory comprising program instructions stored thereon that, when executed by the at least one hardware processor, direct the at least one hardware processor to implement an intelligent interactive method comprising:
executing at least one application that displays a toolbar in the touch screen;
configuring, in response to a first operation of a user on the toolbar, first parameter information of a first function, and activating the first function based on the first parameter information;
generating a first activating flag based on the first function and the first parameter information; and
activating, in response to a triggering operation of the user on the first activating flag, the first function based on the first parameter information.

16. The intelligent interactive device according to claim 15, wherein the intelligent interactive method further comprises:
configuring, in response to a second operation of the user on the toolbar, second parameter information of the first function, and activating the first function based on the second parameter information;
generating a second activating flag based on the first function and the second parameter information; and
activating, in response to a triggering operation of the user on the second activating flag, the first function based on the second parameter information, wherein the first parameter information is different from the second parameter information.

17. The intelligent interactive device according to claim 15, wherein the intelligent interactive method further comprises:
configuring, in response to a third operation of the user on the toolbar, third parameter information of a second function, and activating the second function based on the third parameter information;
generating a third activating flag based on the second function and the third parameter information; and
activating, in response to a triggering operation of the user on the third activating flag, the second function based on the third parameter information, wherein the second function is different from the first function.

18. The intelligent interactive device according to claim 15, wherein the intelligent interactive method further comprises adjusting, in response to a fourth operation of the user on the first activating flag, the first parameter information.

19. The intelligent interactive device according to claim 18, wherein the adjusting, in response to the fourth operation of the user on the first activating flag, the first parameter information comprises:
displaying, in response to the fourth operation of the user on the first activating flag, a parameter selection menu of the first activating flag; and
adjusting, in response to a fifth operation of the user on the parameter selection menu, the first parameter information.

20. A non-transitory computer-readable storage medium having at least one computer program stored thereon that, when executed by at least one hardware processor, an intelligent interaction method for a touch display device is implemented, comprising:
providing at least one application on the touch display device that can display a toolbar;
configuring, in response to a first operation of a user on the toolbar, first parameter information of a first function, and activating the first function based on the first parameter information;
generating a first activating flag based on the first function and the first parameter information; and
activating, in response to a triggering operation of the user on the first activating flag, the first function based on the first parameter information.
